(19) United States
(12) Patent Application Publication
(10) Pub. No.: US 2024/0204389 A1
(43) Pub. Date: Jun. 20, 2024

(54) ANTENNA DEVICE AND IMAGE DISPLAY DEVICE COMPRISING SAME

(71) Applicant: DONGWOO FINE-CHEM CO., LTD., Jeollabuk-do (KR)

(72) Inventors: YUN SEOK OH, Gyeonggi-do (KR); YOUNG GU KANG, Gyeonggi-do (KR); JIN YOUNG PARK, Gyeonggi-do (KR); EUK KUN YOON, Gyeonggi-do (KR); MIN SEOK JANG, Gyeonggi-do (KR)

(21) Appl. No.: 18/589,824

(22) Filed: Feb. 28, 2024

Related U.S. Application Data
(63) Continuation of application No. PCT/KR2022/012853, filed on Aug. 29, 2022.

(30) Foreign Application Priority Data
Aug. 30, 2021 (KR) 10-2021-0114487

(51) Int. Cl. H01Q 1/24; H01Q 1/38; H01Q 1/48; H04M 1/02

(52) U.S. Cl. CPC H01Q 1/243; H01Q 1/38; H01Q 1/48; H04M 1/0266

(57) ABSTRACT

An antenna device according to an exemplary embodiment includes a dielectric layer and an antenna unit which is arranged on the dielectric layer and includes a metal layer and a metal oxide layer, wherein the metal oxide layer has a thickness of 60-100 nm. Accordingly, external visibility can be reduced while maintaining the low resistance of the antenna unit.

### CROSS-REFERENCE TO RELATED APPLICATION AND CLAIM OF PRIORITY

The present application is a continuation application to International Application No. PCT/KR2022/012853 with an International Filing Date of Aug. 29, 2022, which claims the benefit of Korean Patent Application No. 10-2021-0114487 filed on Aug. 30, 2021, at the Korean Intellectual Property Office, the disclosures of which are incorporated by reference herein in their entirety.

### BACKGROUND

### 1. Technical Field

The present invention relates to an antenna device and an image display device including the same. More particularly, the present invention relates to an antenna device including a dielectric layer and an antenna unit, and an image display device including the same.

### 2. Background Art

As information technologies have been developed, a wireless communication technology such as Wi-Fi, Bluetooth, etc., is combined with an image display device in, e.g., a smartphone form. In this case, an antenna may be combined with the image display device to provide a communication function.

As mobile communication technologies have been rapidly developed, an antenna capable of operating a high frequency or ultra-high frequency communication is needed in the image display device.

However, some metal patterns of an antenna may overlap a display unit of the image display apparatus to be visually recognized by a user of the image display device. Accordingly, color and image quality of the image display apparatus may be deteriorated.

Therefore, constructions of the antenna device in which the metal pattern included in the antenna is not visible are needed while maintaining or improving radiation properties of the antenna.

### SUMMARY

According to an aspect of the present invention, there is provided an antenna device that is not easily observed by a user.

According to an aspect of the present invention, there is provided an image display device including an antenna device that is not easily observed by a user.
1. An antenna device, including a dielectric layer; and an antenna unit disposed on the dielectric layer, the antenna unit including a metal layer and a metal oxide layer, the metal oxide layer having a thickness of 60 to 100 nm.
2. The antenna device according to the above 1, wherein the thickness of the metal layer is in a range from 200 to 1,000 nm.
3. The antenna device according to the above 1, wherein each of a* and b* values is in a range from −1.0 to 0.5 in a Commission Internationale de l'Eclairage (CIE) L*a*b* colorimetric system.
4. The antenna device according to the above 3, wherein each of the a* and the b* values is in a range from −0.6 to 0.3.
5. The antenna device according to the above 1, wherein the metal layer and the metal oxide layer are sequentially stacked on the dielectric layer, and a transparent conductive oxide layer is further disposed on the metal oxide layer.
6. The antenna device according to the above 1, wherein a transparent conductive oxide layer is further disposed on the dielectric layer, and the metal layer and the metal oxide layer are sequentially disposed on the transparent conductive oxide layer.
7. The antenna device according to the above 6, wherein the transparent conductive oxide layer is further disposed on the metal oxide layer.
8. The antenna device according to the above 1, wherein the metal oxide layer and the metal layer are sequentially stacked on the dielectric layer, and a transparent conductive oxide layer is further disposed on the metal layer.
9. The antenna device according to the above 1, wherein the antenna unit includes a radiator, a transmission line extending from the radiator, a signal pad connected to a terminal end portion of the transmission line, and a pair of ground pads disposed with the signal pad interposed therebetween and spaced apart from the transmission line and the signal pad.
10. The antenna device according to the above 9, wherein the radiator and the transmission line include a mesh structure.
11. The antenna device according to the above 10, wherein the mesh structure includes a plurality of conductive lines crossing each other, and a line width of each of the conductive lines is in a range from 0.5 to 10 μm.
12. The antenna device according to the above 9, wherein the signal pad and the ground pads include a solid pattern.
13. The antenna device according to the above 9, wherein the metal oxide layer is included only in the radiator and the transmission line.
14. The antenna device according to the above 9, wherein the metal oxide layer is included in all of the radiator, the transmission line, the signal pad and the ground pads.
15. An image display device, including a display panel; the above-described antenna device disposed on the display panel.
16. The image display device according to above 15, further including an optical layer disposed on the display panel and a cover window disposed on the antenna device, wherein the antenna device is disposed between the optical layer and the cover window.

According to embodiments of the present invention, an antenna unit may include a metal layer and a metal oxide layer formed on the metal layer with a thickness of 60 to 100 nm. In this case, the metal oxide layer may reduce a reflectance on a surface of the antenna unit, thereby reducing a pattern visibility caused by a light reflection. Accordingly, an external visibility of the antenna unit may be suppressed, and a display quality of an image display device may be improved.

Additionally, if the metal oxide layer is formed to have the above thickness, the above-described external visibility suppression effect may be implemented while maintaining, e.g., low resistance properties of the antenna unit.

In some embodiments, a thickness of the metal layer may be in a range from 200 to 1,000 nm. In this case, a color matching with the metal oxide layer may be improved, so that the visibility may be further reduced.

In some embodiments, each of a* and b* values in a CIE L*a*b* colorimetric system may be in a range from −0.6 to 0.5. In this case, the antenna unit may be prevented from being visually recognized in a red color or a yellow color. Accordingly, the external visibility of the antenna unit may be further prevented.

### BRIEF DESCRIPTION OF THE DRAWINGS

FIGS. 1 and 2 are schematic cross-sectional views illustrating antenna devices in accordance with example embodiments.

FIG. 3 is a schematic plan view illustrating an antenna device in accordance with example embodiments.

FIG. 4 is a schematic plan view illustrating an antenna device and a circuit board in accordance with example embodiments.

FIG. 5 is a schematic cross-sectional view illustrating an image display device in accordance with example embodiments.

FIGS. 6 and 7 are a schematic cross-sectional view and a plan view, respectively, for describing an image display device in accordance with example embodiments.

FIG. 8 shows results of evaluating color and pattern visibility of the antenna devices according to Examples and Comparative Examples.

FIG. 9 is a graph showing a* and b* values in a CIE L*a*b* colorimetric system of antenna devices according to Examples and Comparative Examples.

### DETAILED DESCRIPTION

Embodiments of the present invention provide an antenna device including a dielectric layer and an antenna unit. Additionally, an image display device including the antenna device is also provided.

Hereinafter, embodiments of the present invention will be described in more detail with reference to drawings. However, since the embodiments provided in the present specification provide some preferred examples and serve to further understand the technical concepts of the present invention together with the above-described contents of the present invention, the present invention should not be interpreted by being limited to the matters described in such embodiments.

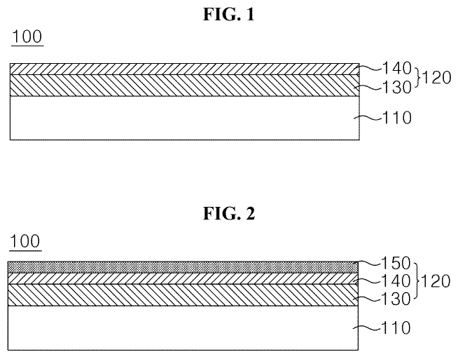

FIGS. 1 and 2 are schematic cross-sectional views illustrating antenna devices in accordance with example embodiments.

Referring to FIGS. 1 and 2, the antenna device 100 may include a dielectric layer 110 and an antenna unit 120 disposed on the dielectric layer 110.

The dielectric layer 110 may include a transparent resin film that may include a polyester-based resin such as polyethylene terephthalate, polyethylene isophthalate, polyethylene naphthalate and polybutylene terephthalate; a cellulose-based resin such as diacetyl cellulose and triacetyl cellulose; a polycarbonate-based resin; an acrylic resin such as polymethyl (meth)acrylate and polyethyl (meth)acrylate; a styrene-based resin such as polystyrene and an acrylonitrile-styrene copolymer; a polyolefin-based resin such as polyethylene, polypropylene, a cycloolefin or polyolefin having a norbornene structure and an ethylene-propylene copolymer; a vinyl chloride-based resin; an amide-based resin such as nylon and an aromatic polyamide; an imide-based resin; a polyethersulfone-based resin; a sulfone-based resin; a polyether ether ketone-based resin; a polyphenylene sulfide resin; a vinyl alcohol-based resin; a vinylidene chloride-based resin; a vinyl butyral-based resin; an allylate-based resin; a polyoxymethylene-based resin; an epoxy-based resin; a urethane or acrylic urethane-based resin; a silicone-based resin, etc. These may be used alone or in a combination of two or more therefrom.

In some embodiments, the dielectric layer 110 may include an adhesive material such as an optically clear adhesive (OCA), an optically clear resin (OCR), etc. In some embodiments, the dielectric layer 110 may include an inorganic insulating material such as silicon oxide, silicon nitride, silicon oxynitride, glass, etc.

In some embodiments, a dielectric constant of the dielectric layer 110 may be adjusted in a range from about 1.5 to about 12. When the dielectric constant exceeds about 12, a driving frequency may be excessively reduced, and a driving in a desired high frequency band may not be implemented.

The antenna unit 120 may be formed on a top surface of the dielectric layer 110. For example, a plurality of the antenna units 120 may be arranged in an array form in a width direction of the dielectric layer 110 or the antenna device 100 to form an antenna unit row.

In example embodiments, the antenna unit 120 may include a metal layer 130 and a metal oxide layer 140.

For example, the metal layer 130 may include silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum. (Mo), calcium (Ca), or an alloy containing at least one of these metals. These may be used alone or in a combination of two or more therefrom.

In one embodiment, the metal layer 130 may include silver (Ag) or a silver alloy (e.g., a silver-palladium-copper (APC) alloy), or copper (Cu) or a copper alloy (e.g., a copper-calcium (CuCa) alloy) to implement a low resistance and a fine line width.

In example embodiments, the metal oxide layer 140 may be an oxide of the metal or the alloy that may be included in the metal layer 130 as described above. For example, the metal oxide layer 140 may be formed by converting a surface of the metal layer 130 into a metal oxide.

For example, the metal oxide layer 140 may be provided as a blackening treated portion. Accordingly, the metal oxide layer 140 may reduce a reflectance on a surface of the antenna unit 120, thereby reducing a pattern visibility due to a light reflection.

In example embodiments, a thickness of the metal oxide layer 140 may be in a range from 60 to 100 nm.

For example, if the thickness of the metal oxide layer 140 is less than 60 nm, a reflectance of the antenna unit 120 may be increased in a wavelength range of a red region (e.g., 630 to 740 nm wavelength range), and a reddish phenomenon may occur. Accordingly, the surface of the antenna unit 120 may be visually recognized by a user as a red color, and a color-sense and a brightness of the image display device, which will be described later, may be deteriorated.

For example, if the thickness of the metal oxide layer 140 exceeds 100 nm, a reflectance of the antenna unit 120 may be increased in a wavelength range of a yellow region (e.g., 570 to 590 nm wavelength range), resulting in a yellowish phenomenon. Accordingly, the surface of the antenna unit 120 may be visually recognized by the user as a yellow color, and the color-sense and the brightness of the image display device, which will be described later, may be deteriorated.

Additionally, if the thickness of the metal oxide layer 140 is in a range from 60 to 100 nm, for example, low resistance properties of the antenna unit 120 may be maintained. Accordingly, the antenna device 100 having enhanced signal efficiency and reduced visibility may be implemented.

For example, the metal oxide layer 140 may cover the surface of the metal layer 130 to improve a corrosion resistance of the antenna unit 120. Accordingly, driving reliability of the antenna device 100 may be improved.

In some embodiments, the thickness of the metal layer 130 may be in a range from 200 to 1,000 nm. In this case, a color matching between the above-described metal oxide layer 140 and the metal layer 130 may be improved while maintaining a thin thickness of the antenna device 100. Accordingly, the visibility of the entire antenna unit 120 may be reduced while maintaining or improving spatial efficiency.

In some embodiments, the antenna device 100 may have an a* value and a b* value of −1.0 to 0.5 in a Commission Internationale de l'Eclairage (CIE) L*a*b* colorimetric system. The a* value and the b* value may each preferably be in a range from −0.6 to 0.3, more preferably from −0.4 to 0.25.

The term “CIE L*a*b* colorimetric system” herein refers to a colorimetric system recommended by CIE in 1976 that may be commonly used in the relevant technology field.

In the colorimetric system, as the a* value becomes greater in a positive range, a color may become closer to a red color. As the a* value becomes smaller in a negative range, a color may become closer to a green color.

In the colorimetric system, as the b* value becomes greater in a positive range, a color may become closer to a yellow color. As the b* value becomes smaller in a negative range, a color may become closer to a blue color.

In the colorimetric system, an L* value may represent, e.g., a reflectance or a brightness.

When the a value and the b* value are in the above-described range in the colorimetric system scheme, excessive reddish or yellowish phenomenon of the antenna unit 120 may be suppressed. Specifically, when the a* value and the b* value satisfy the above range, the reddish phenomenon occurring when the a* value exceeds 0.5 or the yellowish phenomenon occurring when the b* value exceeds 0.5 may be prevented. Additionally, the antenna unit may be prevented from being visually recognized as being green or blue when the a* value and the b* value are excessively reduced in the negative range (e.g., each less than −0.6). Accordingly, the visibility of the antenna unit 120 may be reduced, and a screen display quality of the image display device may be improved.

As illustrated in FIG. 2, the metal layer 130 and the metal oxide layer 140 may be sequentially stacked on the dielectric layer 110, and, in some embodiments, a transparent conductive oxide layer 150 may be further disposed on the metal oxide layer 140.

In this case, corrosion of the metal layer 130 may be additionally suppressed to further improve the corrosion resistance of the antenna unit 120. Accordingly, driving reliability and stability of the antenna device 100 may be further improved.

For example, the transparent conductive oxide layer 150 may include at least one of indium tin oxide (ITO), indium zinc oxide (IZO), indium zinc oxide (ITZO) and zinc oxide (ZnOx).

In some embodiments, the antenna unit 120 may include a stacked structure of the metal layer 130, the metal oxide layer 140 and the transparent conductive oxide layer 150.

For example, the antenna unit may have a triple-layered structure of the metal layer 130—the metal oxide layer 140—the transparent conductive oxide layer 150, the metal oxide layer 140—the metal layer 130—the transparent conductive oxide layer 150 or the transparent conductive oxide layer 150—the metal layer 130—the metal oxide layer 140, or a quadruple-layered structure of the transparent conductive oxide layer 150—the metal layer 130—the metal oxide layer 140—the transparent conductive oxide layer 150.

If the transparent conductive oxide layer 150 is directly stacked on the dielectric layer 110, for example, adhesion of the antenna unit 120 to the dielectric layer may be improved. Accordingly, driving stability and reliability of the antenna device 100 may be improved.

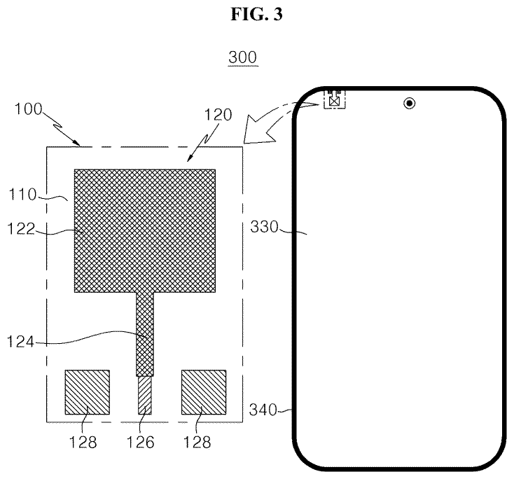

FIG. 3 is a schematic plan view illustrating an antenna device in accordance with example embodiments.

Specifically, FIG. 3 is a schematic plan view illustrating the antenna device 100 according to example embodiments mounted on an image display device 300 to be described later. For example, the antenna device 100 may be formed over a display area 330 and a non-display area 340 to be described later of the image display device 300.

Referring to FIG. 3, the antenna unit 120 may include a radiator 122 and a transmission line 124. The radiator 122 may have, e.g., a polygonal plate shape, and the transmission line 124 may extend from one side of the radiator 122. The transmission line 124 may be formed as a single member substantially integral with the radiator 122 and may have a width narrower than that of the radiator 122.

The antenna unit 120 may further include a signal pad 126. The signal pad 126 may be connected to an end portion of the transmission line 124. In one embodiment, the signal pad 126 may be provided as a substantially integral member with the transmission line 124, and the end portion of the transmission line 124 may be provided as the signal pad 126.

In some embodiments, a ground pad 128 may be disposed around the signal pad 126. For example, a pair of the ground pads 128 may be disposed to face each other with the signal pad 126 interposed therebetween. The ground pad 128 may be electrically and physically separated from the transmission line 124 and the signal pad 126.

The antenna unit 120 or the radiator 122 may be designed to have, e.g., a resonance frequency in a high frequency or ultra-high frequency band of 3G, 4G, 5G, or higher. For example, the resonance frequency of the antenna unit 120 may be in a range from about 20 to about 45 GHz.

In some embodiments, the radiators 122 having different sizes may be arranged on the antenna dielectric layer 110. In this case, the antenna device 100 may be provided as a multi-radiation or multi-band antenna radiating in a plurality of resonance frequency bands.

In some embodiments, the radiator 122 and the transmission line 124 may include a mesh structure to have an improved transmittance. In this case, a dummy mesh pattern (not illustrated) may be formed around the radiator 122 and the transmission line 124.

In some embodiments, the mesh structure may include a plurality of conductive lines intersecting each other, and a line width of each conductive line may be in a range from 0.5 to 10 μm, preferably from 2.0 to 4.0 μm. In this case, an antenna signal loss may be prevented while sufficiently achieving an aperture ratio of the antenna unit 120. Thus, antenna performance may be maintained or improved while preventing the visibility of the antenna device 100 by the combination with the metal oxide layer 140 as described above.

The signal pad 126 and the ground pad 128 may be formed as a solid pattern formed of the above-mentioned metal or alloy in consideration of a reduction of a feeding resistance, an improvement of noise absorption efficiency, horizontal radiation properties, etc.

In an embodiment, the radiator 122 may have the mesh structure, and at least a portion of the transmission line 124 may include a solid metal pattern.

The radiator 122 may be disposed in the display area of the image display device, and the signal pad 126 and the ground pad 128 may be disposed in the non-display area or a bezel area of the image display device. The at least portion of the transmission line 124 may also be disposed in the non-display area or the bezel area.

In some embodiments, the metal oxide layer 140 may be included only in the radiator 122 and the transmission line 124, but may not be included in the signal pad 126 and the ground pad 128. Accordingly, the visibility of the radiator 122 and the transmission line 124 disposed on the display area of the image display device may be suppressed while reducing a process cost.

In some embodiments, the metal oxide layer 140 may be included in all of the radiator 122, the transmission line 124, the signal pad 126 and the ground pad 128. Accordingly, a process for the formation of the antenna unit 120 may be simplified, and the visibility of the antenna device 100 may be suppressed.

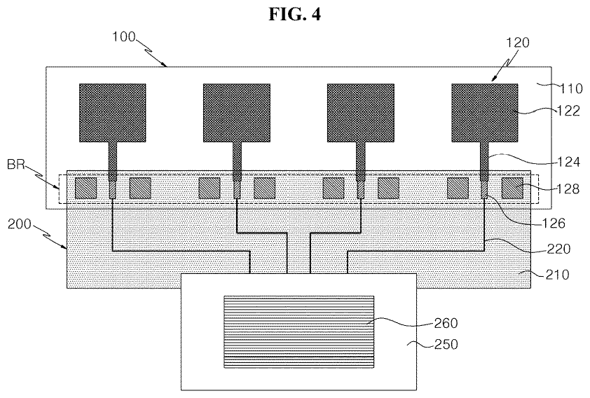

FIG. 4 is a schematic plan view illustrating an antenna device and a circuit board in accordance with example embodiments.

Referring to FIG. 4, the antenna device 100 may be electrically connected to a flexible printed circuit board 200.

The flexible printed circuit board 200 may include a core layer 210 and signal wirings 220 formed on a surface of the core layer 210.

In some embodiments, the dielectric layer 110 may serve as the flexible printed circuit board 200. In this case, the flexible printed circuit board 200 (e.g., the core layer 210 of the flexible printed circuit board 200) may be provided as a substantially integral member with the dielectric layer 110. Further, the signal wiring 220 as described later may be directly connected to the transmission line 124, and the signal pad 126 may be omitted.

The core layer 210 may include, e.g., a flexible resin such as a polyimide resin, a modified polyimide (MPI), an epoxy resin, a polyester, a cycloolefin polymer (COP), a liquid crystal polymer (LCP), etc. The core layer 210 may include an internal insulating layer included in the circuit board 200.

The signal wirings 220 may serve as, e.g., feeding lines. The signal wirings 220 may be arranged on one surface (e.g., a surface facing the antenna unit 120) of the core layer 210.

For example, the flexible printed circuit board 200 may further include a cover-lay film being formed on the one surface of the core layer 210 and covering the signal wirings.

The signal wirings 220 may be connected or bonded to the signal pads 126 of the antenna units 120. For example, one end portions of the signal wirings 220 may be exposed by partially removing the cover-lay film of the flexible printed circuit board 200. The exposed one end portions of the signal wirings 220 may be bonded to the signal pads 126.

For example, a conductive bonding structure such as an anisotropic conductive film (ACF) may be attached onto the signal pads 126, and then a bonding region BR of the flexible printed circuit board 200 on which the one end portions of the signal wirings 220 are located may be disposed on the conductive bonding structure. Thereafter, the bonding region BR of the flexible printed circuit board 200 may be attached to the antenna device 100 through a heat treatment/pressurization process, and the signal wirings 220 may be electrically connected to each signal pad 126.

As illustrated in FIG. 4, the signal wirings 220 may be independently connected or bonded to each of the signal pads 126 of the antenna units 120. In this case, feeding and control signals may be independently supplied to each antenna unit 120 from an antenna driving integrated circuit (IC) chip 260.

In some embodiments, a predetermined number of the antenna units 120 may be coupled by the signal wiring 220.

In example embodiments, an intermediate circuit board 250 may be disposed to be physically and electrically connected to the flexible printed circuit board 200. For example, the antenna driving IC chip 260 may be mounted on the intermediate circuit board 250 by, e.g., a surface mounting technology (SMT).

The term “intermediate circuit board” used herein may comprehensively refer to a connector, a circuit structure or a circuit board located between the flexible printed circuit board 200 and the antenna driving IC chip 260.

For example, the intermediate circuit board 250 may include a main board of the image display device, a rigid printed circuit board and various antenna package boards. Additionally, the intermediate circuit board 250 may include a main board, a rigid printed circuit board, various antenna packages, etc., on which a connector is mounted.

If the intermediate circuit board 250 is the rigid printed circuit board, the intermediate circuit board 250 may have, e.g., higher strength or lower ductility than that of the flexible printed circuit board 200. Accordingly, mounting stability of the antenna driving IC chip 260 may be improved. For example, if the intermediary circuit board 250 is the rigid printed circuit board, a resin (e.g., an epoxy resin) layer such as a prepreg in which an inorganic material such as a glass fiber is impregnated may be included as a base insulating layer or a core layer, and signal wirings distributed at an inside and on a surface of the base insulating layer may be included.

The feeding and driving signals may be applied from the antenna driving IC chip 260 to the antenna units 120 through the signal wirings 220. For example, a circuit or a contact for electrically connecting the antenna driving IC chip 260 to the signal wirings 220 may be further included in the flexible printed circuit board 200.

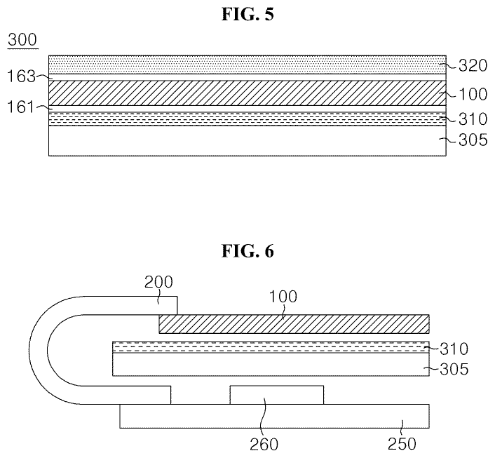

FIG. 5 is a schematic cross-sectional view illustrating an image display device in accordance with example embodiments.

Referring to FIG. 5, the image display device 300 may include a display panel 305 and the above-described antenna device 100 disposed on the display panel 305.

In example embodiments, an optical layer 310 may be further included on the display panel 305, and a cover window 320 may be disposed on the antenna device 100.

For example, the optical layer 310 may be a polarizing layer including a polarizer or a polarizing plate.

The cover window 320 may include, e.g., an ultra-thin glass (UTG) or a transparent resin film. Accordingly, an external impact applied to the antenna device 100 may be reduced or buffered.

For example, the antenna device 100 may be disposed between the optical layer 310 and the cover window 320. In this case, the dielectric layer 110 and the optical layer 310 disposed under the antenna unit 120 may serve as the dielectric layer of the antenna unit 120 together. Accordingly, an appropriate dielectric constant may be achieved, and thus antenna performance of the antenna device 100 may be sufficiently implemented.

Further, even when the antenna device 100 is disposed on the optical layer 310 based on a viewing surface, an external visual recognition of the antenna unit may be suppressed by the metal oxide layer 140 as described above. Accordingly, display quality of the image display device may be improved while maintaining the sufficient antenna dielectric constant.

For example, the optical layer 310 and the antenna device 100 may be stacked by the first adhesive layer 161, and the antenna device 100 and the cover window 320 may be stacked by the second adhesive layer 163.

The first adhesive layer 161 and the second adhesive layer 163 may include, e.g., an adhesive material such as an optical clear adhesive (OCA), an optical clear resin (OCR), etc.

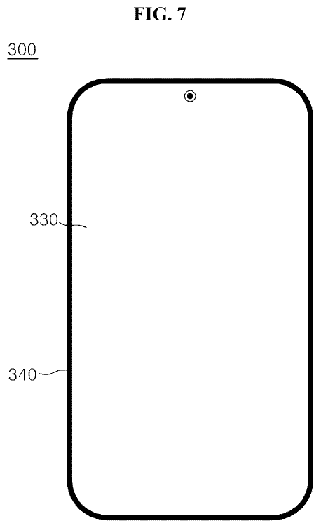

FIGS. 6 and 7 are a schematic cross-sectional view and a plan view, respectively, for describing an image display device in accordance with example embodiments.

Referring to FIGS. 6 and 7, the image display device 300 may be implemented in the form of, e.g., a smart phone form, and FIG. 7 shows a front portion or a window surface of the image display device 300. The front portion of the image display device 300 may include a display area 330 and a peripheral area 340. The peripheral area 340 may correspond to, e.g., a light-shielding portion or a bezel portion of the image display device.

The antenna device 100 included in the above-described antenna package may be disposed toward the front surface of the image display device 300, and may be disposed on, e.g., the display panel 305. In an embodiment, the radiators 122 may be at least partially disposed in the display area 330.

In this case, the radiator 122 may include a mesh structure, and a reduction of transmittance due to the radiator 122 may be prevented. The pads 126 and 128 included in the antenna unit 120 may be formed as a solid metal pattern. In this case, the pads 126 and 128 may be disposed in the peripheral area 340 to prevent degradation of the image quality.

In some embodiments, the flexible printed circuit board 200 may extend toward the intermediate circuit board 250 (e.g., the main board) on which the antenna driving IC chip 260 is mounted and may be bent along a lateral side curved profile of the display panel 305 to be disposed at a rear portion of the image display device 300.

The flexible printed circuit board 200 and the intermediate circuit board 250 may be bonded or interconnected through a connector, thereby implementing a feeding to the antenna device 100 and an antenna driving control by the antenna driving IC chip 260.

Hereinafter, experimental examples including specific examples and comparative examples are proposed to enhance understanding of the present invention. However, the following examples are only given for illustrating the present invention and those skilled in the related art will obviously understand that various alterations and modifications are possible within the scope and spirit of the present invention. Such alterations and modifications are duly included in the appended claims.

### Example 1

A 500 nm-thick copper (Cu) layer (e.g., corresponding to the metal layer 130) was formed on a polyethylene terephthalate (PET) layer by a sputtering method (90° C., 23 KW condition).

A copper oxide (CuO) layer (e.g., corresponding to the metal oxide layer 140) having a thickness of 61 nm was formed on the copper layer by a sputtering under the same conditions.

An IZO layer (e.g., corresponding to the transparent conductive oxide layer 150) was formed on the copper oxide layer by a sputtering method under the same conditions.

Thereafter, the copper layer, the copper oxide layer and the IZO layer were etched by the photolithography process to manufacture an antenna unit including a radiator and a transmission line with having a mesh structure, and a signal pad and a ground pad having a solid pattern.

A line width of conductive lines included in the mesh structure was 2.5 μm.

A polarizing layer was stacked on a display panel of a smartphone, and an antenna device including the antenna unit and the PET layer was stacked on the polarizing layer to manufacture an image display device.

A glass was stacked as a cover window on the antenna device. The polarizing layer and the antenna device, and the antenna device and the cover window were stacked by an OCA adhesive layer.

a* and b* values in a CIE L*a*b* colorimetric system of the formed antenna device were measured and calculated as 0.05 and −0.55, respectively.

Specifically, the a* and b* values of the antenna device were measured using an SCI mode of a spectrophotometer CM-3600d (manufactured by KONIKA MINOLTA).

### Examples 2 to 10

An antenna unit and an image display device were manufactured by the same method as that in Example 1, except that the antenna unit was manufactured such that the thickness of the copper layer, the thickness of the copper oxide layer, the line width of the conductive lines, and the a* and b* values in the CIE L*a*b* colorimetric system were adjusted as shown in Table 1 below.

### Example 11

An antenna unit and an image display device were manufactured by the same method as that in Example 4, except that the IZO layer was not formed on the copper oxide layer.

### Comparative Examples 1 to 5

An antenna unit and an image display device were manufactured by the same method as that in Example 1, except that the antenna unit was manufactured such that the thickness of the copper oxide layer and the a* and b* values in the CIE L*a*b* colorimetric system were adjusted as shown in Table 1 below.

### Comparative Example 6

An antenna unit and an image display device were manufactured by the same method as that in Example 1, except that the copper oxide layer and the IZO layer were not formed.

TABLE 1

| | thickness | | line | | | |
|---|---|---|---|---|---|---|
| | of copper | thickness | width of | forma- | CIE L*a*b* | |
| | oxide | of copper | conductive | tion of | colorimetric | |
| | layer | layer | line | IZO | system | |
| | (nm) | (nm) | (μm) | layer | a* | b* |
| Example 1 | 61 | 500 | 2.5 | ◯ | 0.05 | −0.55 |
| Example 2 | 68 | 500 | 2.5 | ◯ | 0.14 | −0.46 |
| Example 3 | 76 | 500 | 2.5 | ◯ | −0.06 | −0.46 |
| Example 4 | 84 | 500 | 2.5 | ◯ | −0.12 | −0.33 |
| Example 5 | 92 | 500 | 2.5 | ◯ | −0.09 | −0.21 |
| Example 6 | 100 | 500 | 2.5 | ◯ | −0.11 | −0.07 |
| Example 7 | 84 | 190 | 2.5 | ◯ | −0.13 | −0.31 |
| Example 8 | 84 | 1,020 | 2.5 | ◯ | −0.14 | −0.32 |
| Example 9 | 84 | 500 | 0.4 | ◯ | −0.11 | −0.33 |
| Example 10 | 84 | 500 | 10.2 | ◯ | −0.13 | −0.30 |
| Example 11 | 84 | 500 | 2.5 | X | −0.10 | −0.31 |
| Comparative | 40 | 500 | 2.5 | ◯ | 1.20 | 0.16 |
| Example 1 | | | | | | |
| Comparative | 48 | 500 | 2.5 | ◯ | 0.66 | −0.27 |
| Example 2 | | | | | | |
| Comparative | 56 | 500 | 2.5 | ◯ | 0.52 | −0.52 |
| Example 3 | | | | | | |
| Comparative | 108 | 500 | 2.5 | ◯ | −0.10 | 0.54 |
| Example 4 | | | | | | |
| Comparative | 116 | 500 | 2.5 | ◯ | −0.11 | 0.85 |
| Example 5 | | | | | | |
| Comparative | — | 500 | 2.5 | X | — | — |
| Example 6 | | | | | | |

### Experimental Example

### (1) Evaluation on Visibility

In the image display device manufactured according to the above-described Examples and Comparative Examples, a portion on which the antenna unit was mounted was visually observed to confirm whether the antenna unit was visually recognized.
◯: Clearly recognized
Δ: Unclearly recognized in a specific direction
X: Unrecognized from all directions

### (2) Measurement of Sheet Resistance (Rs, Ohm/Sq)

The antenna units manufactured according to the above-described Examples and Comparative Examples were measured using a sheet resistance meter Resist Test RT-80.

Specifically, three probes in RT-80 contacted one surface of the antenna unit, five points were measured within a 100 mm*100 mm area, and a total 150 points were measured for each divided plate to measure a total sheet resistance of the antenna unit.

### (3) Evaluation on Corrosion Resistance

The antenna unit manufactured according to the above-described Examples and Comparative Examples was left in an environment of 85° C. and a relative humidity of 85%, and a time at which corrosion was initially observed was measured.

TABLE 2

| | visual | sheet resistance | corrosion resistance |
|---|---|---|---|
| | recognition | (ohm/sq) | (hr) |
| Example 1 | X | 0.042 | 503 |
| Example 2 | X | 0.041 | 505 |
| Example 3 | X | 0.041 | 501 |
| Example 4 | X | 0.042 | 510 |
| Example 5 | X | 0.042 | 506 |
| Example 6 | X | 0.041 | 507 |
| Example 7 | Δ | 0.042 | 502 |
| Example 8 | Δ | 0.042 | 503 |
| Example 9 | X | 0.045 | 505 |
| Example 10 | Δ | 0.041 | 504 |
| Example 11 | X | 0.042 | 253 |
| Comparative | ◯ | 0.042 | 509 |
| Example 1 | | | |
| Comparative | ◯ | 0.042 | 505 |
| Example 2 | | | |
| Comparative | ◯ | 0.041 | 506 |
| Example 3 | | | |
| Comparative | ◯ | 0.042 | 502 |
| Example 4 | | | |
| Comparative | ◯ | 0.042 | 498 |
| Example 5 | | | |
| Comparative | ◯ | 0.041 | 110 |
| Example 6 | | | |

Referring to Table 2, in Examples where the metal oxide layer having a thickness of 60 to 100 nm was stacked on the metal layer, the external visibility of the antenna unit was suppressed while generally maintaining low resistance properties compared to those from Comparative Examples where the thickness range was not satisfied.

However, in Example 7 where the thickness of the metal layer was less than 200 nm and Example 8 where the thickness of the metal layer exceeded 1,000 nm, a color matching with the metal oxide layer was degraded, and the visual recognition to the user was unclearly caused in the specific direction.

Additionally, in Example 9 where the line width of the conductive lines of the mesh structure was less than 0.5 μm, the sheet resistance was increased due to the relatively narrow line width compared to those from other Examples.

In Example 10 where the line width of the conductive lines exceeded 10 μm, the aperture ratio of the mesh structure was relatively lowered, and the visual recognition to the user was unclearly caused in the specific direction.

Further, in Example 11 where the transparent conductive oxide layer was not formed, the corrosion resistance was lowered compared to those from other Examples including the transparent conductive oxide layer.

In Comparative Example 6 where the metal oxide layer and the transparent conductive oxide layer were not formed, the easily oxidizable copper layer was directly exposed, resulting in a significant reduction of the corrosion resistance of the antenna unit.

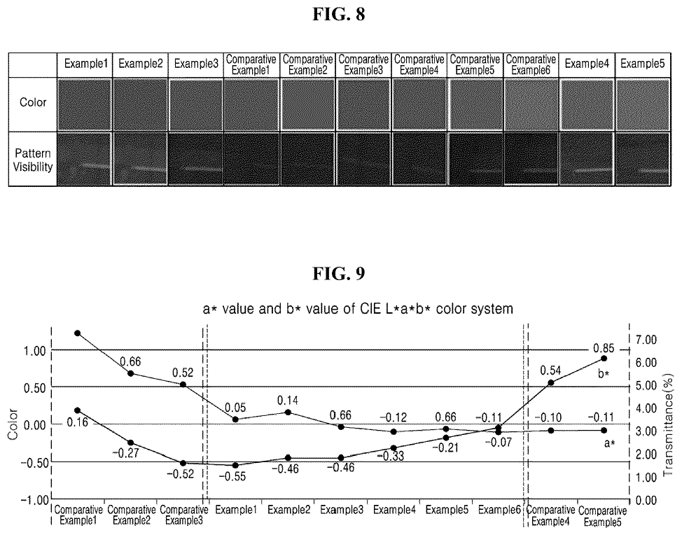

FIG. 8 shows results of evaluating color and pattern visibility of the antenna devices according to Examples and Comparative Examples. FIG. 9 is a graph showing a* and b* values in a CIE L*a*b* colorimetric system and colors according to the values of antenna devices according to Examples and Comparative Examples.

Specifically, FIGS. 8 and 9 show evaluation results of colors, visual recognition and a* value/b* value according to thicknesses in Examples 1 to 6 and Comparative Examples 1 to 5 which have different thicknesses of the metal oxide layer. In the evaluation of the pattern visibility of FIG. 8, the visual recognition of the antenna unit was determined at an upper side based on at a lower right segment.

Referring to FIGS. 8 and 9, in Comparative Examples 1 to 3 where the thickness of the metal oxide layer was less than 60 nm, the a* value of the CIE L*a*b* colorimetric system exceeded 0.5, and a reddish phenomenon occurred to cause a visual recognition of a red-based pattern from an outside.

Additionally, in Comparative Examples 4 and 5 where the thickness of the metal oxide layer exceeded 100 nm, the b* value of the CIE L*a*b* colorimetric system exceeded 0.5, and a yellowish phenomenon occurred to cause a visual recognition of a yellow-based pattern from the outside.

As shown in FIGS. 8 and 9, the external visibility was suppressed in the antenna units according to Examples 1 to 6 and both the a and b* values were 0.5 or less, thereby preventing the reddish and yellowish phenomena.

What is claimed is:

1. An antenna device comprising:
a dielectric layer; and
an antenna unit disposed on the dielectric layer, the antenna unit comprising a metal layer and a metal oxide layer, the metal oxide layer having a thickness of 60 to 100 nm.

2. The antenna device according to claim 1, wherein the thickness of the metal layer is in a range from 200 to 1,000 nm.

3. The antenna device according to claim 1, wherein each of a* and b* values is in a range from −1.0 to 0.5 in a Commission Internationale de l'Eclairage (CIE) L*a*b* colorimetric system.

4. The antenna device according to claim 3, wherein each of the a* and the b* values is in a range from −0.6 to 0.3.

5. The antenna device according to claim 1, wherein the metal layer and the metal oxide layer are sequentially stacked on the dielectric layer, and
a transparent conductive oxide layer is further disposed on the metal oxide layer.

6. The antenna device according to claim 1, wherein a transparent conductive oxide layer is further disposed on the dielectric layer, and the metal layer and the metal oxide layer are sequentially disposed on the transparent conductive oxide layer.

7. The antenna device according to claim 6, wherein the transparent conductive oxide layer is further disposed on the metal oxide layer.

8. The antenna device according to claim 1, wherein the metal oxide layer and the metal layer are sequentially stacked on the dielectric layer, and
a transparent conductive oxide layer is further disposed on the metal layer.

9. The antenna device according to claim 1, wherein the antenna unit comprises a radiator, a transmission line extending from the radiator, a signal pad connected to a terminal end portion of the transmission line, and a pair of ground pads disposed with the signal pad interposed therebetween and spaced apart from the transmission line and the signal pad.

10. The antenna device according to claim 9, wherein the radiator and the transmission line include a mesh structure.

11. The antenna device according to claim 10, wherein the mesh structure comprises a plurality of conductive lines crossing each other, and
a line width of each of the conductive lines is in a range from 0.5 to 10 μm.

12. The antenna device according to claim 9, wherein the signal pad and the ground pads include a solid pattern.

13. The antenna device according to claim 9, wherein the metal oxide layer is included only in the radiator and the transmission line.

14. The antenna device according to claim 9, wherein the metal oxide layer is included in all of the radiator, the transmission line, the signal pad and the ground pads.

15. An image display device comprising:
a display panel;
the antenna device of claim 1 disposed on the display panel.

16. The image display device according to claim 15, further comprising an optical layer disposed on the display panel and a cover window disposed on the antenna device,
wherein the antenna device is disposed between the optical layer and the cover window.
